(19) United States
(12) Patent Application Publication
(10) Pub. No.: US 2009/0051267 A1
(43) Pub. Date: Feb. 26, 2009

(54) Fabrication method for carbon fiber, carbon fiber electron source, and field emission display device

(75) Inventor: Tomohiro Kato, Kyoto (JP)

Correspondence Address: RABIN & Berdo, PC, 1101 14TH STREET, NW, SUITE 500, WASHINGTON, DC, 20005, US

(73) Assignee: ROHM CO., LTD., Kyoto-fu (JP)

(21) Appl. No.: 12/222,973

(22) Filed: Aug. 21, 2008

(30) Foreign Application Priority Data
Aug. 22, 2007 (JP) 2007-216140

(51) Int. Cl. H01J 1/62; H01J 19/06; H01J 9/04

(52) U.S. Cl. 313/495; 313/311; 445/50

(57) ABSTRACT

A fabrication method for carbon fiber which can prevent abnormal growth from electrode wiring metal, and can be formed a carbon nano-tube with high-density and uniform, by a simple and cheap method and the fabrication method includes process steps: forming a cathode electrode on a substrate; forming a first insulating film on the cathode electrode; forming a gate electrode on the first insulating film; forming a hole which reaches to the cathode electrode surface into the first insulating film; forming a catalyst crystallite nucleus on a bottom of the hole; oxidized forming a second insulating film on the gate electrode surface; and forming a carbon nano-tube on the catalyst crystallite nucleus; a carbon fiber electron source of high-output current density; and FED device which has high-intensity and large capacity with high current density, are provided.

### CROSS REFERENCE TO RELATED APPLICATION AND INCORPORATION BY REFERENCE

This application is based upon and claims the benefit of priority from prior Japanese Patent Application No. P2007-216140 filed on Aug. 22, 2007, the entire contents of which are incorporated herein by reference.

### BACKGROUND OF THE INVENTION

1. Field of the Invention

The present invention relates to a fabrication method for a carbon fiber, and in particular, relates to a fabrication method for a carbon fiber for preventing abnormal growth by electrode oxidation, and a carbon fiber electron source and an FED (Field Emission Display) devices which apply the fabricated carbon fiber.

2. Description of the Related Art

In a fabrication method of the conventional carbon nano-tube, a catalyst is formed by sputtering in a hole by using a resist as a mask (for example, refer to Patent Document 1.). Furthermore, it is necessary to perform lift off of the resist after catalyst sputtering (for example, refer to Patent Document 2.).

However, there is a problem that the lift off of the resist after catalyst sputtering cannot be carried out since the resist denatures in a dry hole formation process accompanying miniaturization of a hole diameter.

Although there is no denaturalization of resist in wet hole formation, the hole etching is performed isotropic, and therefore cramming into one dot has a limit.

Moreover, even if a minute vertical hole is formed, there is a problem that an aspect ratio of a hole becomes large, catalyst adhesion in a hole internal wall is made at the time of catalyst sputtering, and then abnormal growth of a carbon fiber from a wall surface occurs in a growing process.

FIG. 1 is a figure explaining a relation of growth temperature and growth time in a growing process of a carbon nano-tube according to the conventional fabrication method for carbon fiber. In the conventional fabrication method for carbon fiber, as shown in FIG. 1, it is made to rise gradually from room temperature (RT), and, for example, the carbon nano-tube is grown up in about 10 minutes to about 30 minutes with growth temperature of about 580 degrees C.

Moreover, FIG. 2 is an expanded schematic section structure chart showing a catalyst metal layer 28 in a hole 11 formed by using the conventional fabrication method for carbon fiber. In the conventional fabrication method for carbon fiber, the catalyst metal layer 28 is formed by sputtering of a catalytic metal on a surface of a cathode electrode 10 in the hole 11. The hole 11 formed in a insulating film 12 is formed by wet etching technology or dry etching technology.

Moreover, FIG. 3 is an expanded schematic section structure chart showing an abnormal growth 44 on a gate electrode 14, and shows a carbon nano-tube 4 in the hole 11 formed by using the conventional fabrication method for carbon fiber. In the condition that V_{GK} is applied between the gate electrode 14 and the cathode electrode 10 placed on the insulating film 12 and V_{GA} is applied between an anode electrode 6 and the gate electrode 14, if the carbon nano-tube 4 is grown up, as shown in FIG. 3, the abnormal growth 44 will be observed on the gate electrode 14 by growing condition shown in FIG. 1.

Abnormal growth is performed also from wiring metals (Cr, Mo) with low catalytic ability except a catalytic metal (Fe, Ni, Co) at the time of carbon fiber growth. Abnormal electron emission from the whole wiring occurs because of the abnormal growth being performed from wiring metals (Cr, Mo). Accordingly the abnormal electron emission in a metal electrode line will occur. As a result, there is a problem that electron emission from each of the every matrix electrode cannot be performed.

Although a covering process of metal electrode line with insulating films, such as silicon oxide (SiO₂), is also considered, it becomes a complicated process.

FIG. 4 shows a field emission matrix electrode of CNT-FED formed by using the conventional fabrication method for carbon fiber, and is a schematic perspective diagram showing the abnormal growth 44 on the gate electrode 14 in 2×2 matrices which stuffs a plurality of holes into one dot.

Moreover, FIG. 5 shows an expanded cross section SEM photograph to which a carbon nano-tube formed by using the conventional fabrication method for carbon fiber. As clearly from FIG. 5, the abnormal growth 44 from the gate electrode 14 is observed on the surface of the gate electrode 14 in a part shown by the reference symbol A. Moreover, the abnormal growth is observed also on the surface of the cathode electrode 10 except a growth part of the carbon nano-tube 4 in the hole 11.

According to the abnormal growth 44 from such the gate electrode 14, there is a problem that it is anxious about electron emission in a gate electrode line if anode voltage is increased, and the electron emission from each of the every matrix electrode cannot be performed.

Furthermore, as shown in FIG. 5, if the carbon nano-tube 4 is grown up for long, it is anxious also about a short circuit between an edge part of the carbon nano-tube 4 and the gate electrode 14.

### Patent Document 1:

Japanese Patent Application Laying-Open Publication No. 2005-72171

### Patent Document 2:

Japanese Patent Application Laying-Open Publication No. 2006-40723

The abnormal growth is performed also from a wiring metal (Cr, Mo) by the gate electrodes and the cathode electrodes with low catalytic ability except the catalytic metal (Fe, Ni, Co), at the time of carbon fiber growth. Abnormal electron emission from the whole wiring occurs because of the abnormal growth being performed from wiring metals (Cr, Mo).

### SUMMARY OF THE INVENTION

According to one aspect of the present invention, a fabrication method for carbon fiber includes steps of forming a cathode electrode on a substrate; forming a first insulating film on the cathode electrode; forming a gate electrode on the first insulating film; forming a hole which reaches to a surface of the cathode electrode into the first insulating film; forming a catalyst crystallite nucleus on a bottom of the hole; oxidized forming a second insulating film on the gate electrode surface; and forming a carbon nano-tube on the catalyst crystallite nucleus.

According to other one aspect of the present invention, a fabrication method for carbon fiber includes steps of placing field emission matrix electrode structure into a plating bath, and the field emission matrix electrode structure being composed of a cathode electrode being placed on a substrate, a first insulating film being placed on the cathode electrode, a gate electrode being placed on the first insulating film and intersecting perpendicularly with the cathode electrode, and a hole formed to the cathode electrode surface into the first insulating film; electrodepositing a catalyst into the hole using the cathode electrode of a bottom of the hole as a negative cathode and the gate electrode as a positive anode, and adhering a catalyst crystallite nucleus of nano order on the cathode electrode of the bottom of the hole, when the catalyst become a nucleus of growth of the carbon fiber is electrodeposited;

oxidizing the gate electrode surface and forming a second insulating film according to a previous oxidation process; and growing up a carbon nano-tube to the catalyst crystallite nucleus.

According to other one aspect of the present invention, a fabrication method for carbon fiber includes steps of placing field emission matrix electrode structure into a plating bath, and the field emission matrix electrode structure being composed of a cathode electrode being placed on a substrate, a first insulating film being placed on the cathode electrode, a gate electrode being placed on the first insulating film and intersecting perpendicularly with the cathode electrode, and a hole formed to the cathode electrode surface into the first insulating film; opposing to the cathode electrode centering on the gate electrode, placing an opposite negative cathode into the plating bath, and making potential of the opposite negative cathode into lower voltage than the gate electrode; electrodepositing a catalyst into the hole using the cathode electrode of a bottom of the hole as a negative cathode and the gate electrode as a positive anode, and adhering a catalyst crystallite nucleus of nano order on the cathode electrode of the bottom of the hole, when the catalyst become a nucleus of growth of the carbon fiber is electrodeposited; oxidizing the gate electrode surface and forming a second insulating film according to a previous oxidation process; and growing up a carbon nano-tube to the catalyst crystallite nucleus.

According to other one aspect of the present invention, a carbon fiber electron source includes a cathode electrode placed on a substrate; a first insulating film placed on the cathode electrode; a gate electrode placed on the first insulating film; a catalyst crystallite nucleus formed on a bottom of a hole formed to the cathode electrode surface into the first insulating film; a second insulating film formed on the gate electrode surface; and a carbon nano-tube formed on the catalyst crystallite nucleus.

According to other one aspect of the present invention, a field emission display device includes a cathode electrode placed on a substrate; a first insulating film placed on the cathode electrode; a gate electrode placed on the first insulating film; an anode electrode placing the gate electrode in the middle and placed an upper part of the gate electrode of the opposite side to the cathode electrode; a catalyst crystallite nucleus formed on a bottom of a hole formed to the cathode electrode surface into the first insulating film; a second insulating film formed on the gate electrode surface; a carbon nano-tube formed on said catalyst crystallite nucleus; and a fluorescent material placed on a back side which opposes the cathode electrode of the anode electrode.

According to the fabrication method for carbon fiber of the present invention, abnormal growth from a wiring metal can be prevented by performing previous oxidation of the substrate before a growing of the carbon nano-tube.

Moreover, according to the fabrication method for carbon fiber of the present invention, the carbon nano-tube can use selectivity of growing up from an oxidized catalytic metal.

Moreover, according to the fabrication method for carbon fiber of the present invention, since the insulating film is formed on the surface of the gate electrode, when carbon fiber grows up equal to or more than an arbitrary length and contacts a gate electrode, it is hard to become electrically short.

Moreover, according to the fabrication method for carbon fiber of the present invention, when reducing the abnormal growth, since it does not need to cover the electrode with the insulating film of SiO₂ etc., the process becomes simple.

Moreover, according to the fabrication method for carbon fiber according to the present invention, it becomes possible to shorten or to control thickness for the carbon fiber grown-up too much for long, by oxidizing again.

According to the fabrication method for carbon fiber of the present invention, the abnormal growth from wiring metal electrode is prevented by a simple and cheap method by using ultrasonic selectively catalyst plating method using a field emission matrix electrode, and the carbon nano-tube of nano order based on a catalyst crystallite nucleus of nano order can be formed with high density and uniform.

Furthermore, according to the carbon fiber electron source of the present invention, the carbon fiber can be applied fabricated by the above-mentioned fabrication method for carbon fiber, and high-output current density can be achieved.

Furthermore, according to the FED device of the present invention, the carbon fiber can be applied fabricated by the above-mentioned fabrication method for carbon fiber, and high-intensity with high current density, large capacity, and a big screen can be achieved.

### BRIEF DESCRIPTION OF DRAWINGS

FIG. 1 is a figure for explaining a relation of growth temperature and growth time in a growing process of a carbon nano-tube according to a conventional fabrication method for carbon fiber.

FIG. 2 is an expanded schematic section structure chart where a catalyst metal layer in a hole formed by using the conventional fabrication method for carbon fiber.

FIG. 3 shows a carbon nano-tube in a hole formed by using the conventional fabrication method for carbon fiber, and is an expanded schematic section structure chart showing abnormal growth on a gate electrode 14.

FIG. 4 shows a schematic perspective diagram of field emission matrix electrode of CNT-FED formed by using the conventional fabrication method for carbon fiber, and is showing abnormal growth on the gate electrode 14 in 2×2 matrices which stuffed a plurality of holes into one dot.

FIG. 5 shows an expanded cross section SEM photograph of a carbon nano-tube formed by the conventional fabrication method for carbon fiber.

FIG. 6 is a schematic section structure chart of a CNT-FED device formed by using a fabrication method for carbon fiber according to a first embodiment of the present invention.

FIG. 7 is an expanded schematic section structure chart of a carbon fiber electron source formed by using the fabrication method for carbon fiber according to the first embodiment of the present invention.

FIG. 8 is an expanded schematic section structure chart of another carbon fiber electron source formed by using the fabrication method for carbon fiber according to the first embodiment of the present invention.

FIG. 9A is a schematic section structure chart showing one process of the fabrication method for carbon fiber by minute holes formation by dry etching as the first embodiment of the present invention, and is a process chart for preparing a substrate.

FIG. 9B is a schematic section structure chart showing one process of the fabrication method for carbon fiber by minute holes formation by dry etching as the first embodiment of the present invention, and is a cathode electrode formation process chart by sputtering.

FIG. 9C is a schematic section structure chart showing one process of the fabrication method for carbon fiber by minute holes formation by dry etching as the first embodiment of the present invention, and is a cathode electrode line photo lithography process chart after a resist-coating application.

FIG. 9D is a schematic section structure chart showing one process of the fabrication method for carbon fiber by minute holes formation by dry etching as the first embodiment of the present invention, and is a lift off process chart after the cathode electrode formation.

FIG. 9E is a schematic section structure chart showing one process of the fabrication method for carbon fiber by minute holes formation by dry etching as the first embodiment of the present invention, and is an insulating film depositing process chart.

FIG. 9F is a schematic section structure chart showing one process of the fabrication method for carbon fiber by minute holes formation by dry etching as the first embodiment of the present invention, and is a gate electrode formation process chart by sputtering.

FIG. 10A is a schematic section structure chart showing one process of the fabrication method for carbon fiber by minute holes formation by dry etching as the first embodiment of the present invention, and is a gate electrode line photo lithography process chart after a resist-coating application.

FIG. 10B is a schematic section structure chart showing one process of the fabrication method for carbon fiber by minute holes formation by dry etching as the first embodiment of the present invention, and is a lift off process chart after gate electrode line etching.

FIG. 10C is a schematic section structure chart showing one process of the fabrication method for carbon fiber by minute holes formation by dry etching as the first embodiment of the present invention, and is a minute holes pattern formation process chart after a resist application.

FIG. 10D is a schematic section structure chart showing one process of the fabrication method for carbon fiber by minute holes formation by dry etching as the first embodiment of the present invention, and is a resist-ashing process chart after hole dry etching.

FIG. 11 shows a field emission matrix electrode of CNT-FED formed by using the fabrication method for carbon fiber according to the first embodiment of the present invention, and is a schematic perspective diagram of 2×2 matrices which stuffs a plurality of holes into one dot.

FIG. 12 is a schematic configuration diagram of a carbon fiber fabricating apparatus utilized by ultrasonic selectively catalyst plating method.

FIG. 13A is a schematic section structure chart showing one process of the fabrication method for carbon fiber by dry hole formation as the first embodiment of the present invention, and is a resist patterning process chart.

FIG. 13B is a schematic section structure chart showing one process of the fabrication method for carbon fiber by dry hole formation as the first embodiment of the present invention, and is a hole formation process chart by dry etching.

FIG. 13C is a schematic section structure chart showing one process of the fabrication method for carbon fiber by dry hole formation as the first embodiment of the present invention, and is a formation process chart of a catalyst crystallite nucleus utilized by ultrasonic selectively catalyst plating method.

FIG. 13D is a schematic section structure chart showing one process of the fabrication method for carbon fiber by dry hole formation as the first embodiment of the present invention, and is a previous oxidation process chart.

FIG. 14 shows a growing process of a carbon nano-tube which performs previous oxidation in the fabrication method for carbon fiber according to the first embodiment of the present invention, and is a figure for explaining relation between growth temperature and growth time.

FIG. 15 is an expanded cross section SEM photograph of a carbon fiber obtained as a result of growing up a carbon nano-tube after previous oxidation treatment, in the fabrication method for carbon fiber according to the first embodiment of the present invention.

FIG. 16 is an expanded cross section SEM photograph near the gate electrode before the previous oxidation treatment, in the fabrication method for carbon fiber according to the first embodiment of the present invention.

FIG. 17 shows an EDX ultimate material analysis result of A1 part of the gate electrode of FIG. 16.

FIG. 18 is an expanded cross section SEM photograph near the gate electrode after the previous oxidation treatment, in the fabrication method for carbon fiber according to the first embodiment of the present invention.

FIG. 19A shows an EDX ultimate material analysis result of B1 part formed by Cr oxide film of FIG. 18.

FIG. 19B shows an EDX ultimate material analysis result of B2 part of the gate electrode of FIG. 18.

FIG. 20 is an Auger analysis result of a surface of the natural oxidation Cr of the gate electrode, in the fabrication method for carbon fiber according to the first embodiment of the present invention.

FIG. 21 shows an Auger analysis result whose depth from a surface of the natural oxidation Cr of the gate electrode is 2 nm, in the fabrication method for carbon fiber according to the first embodiment of the present invention.

FIG. 22 shows an Auger analysis result whose depth from a surface of the natural oxidation Cr of the gate electrode is 10 nm, in the fabrication method for carbon fiber according to the first embodiment of the present invention.

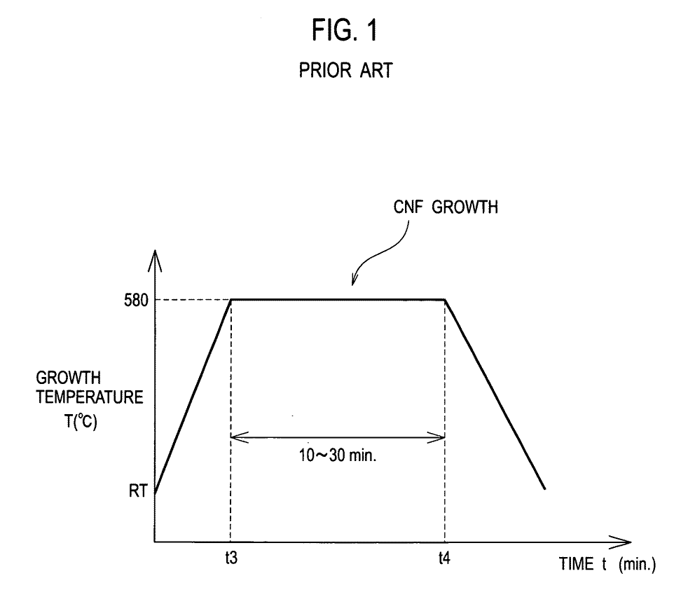

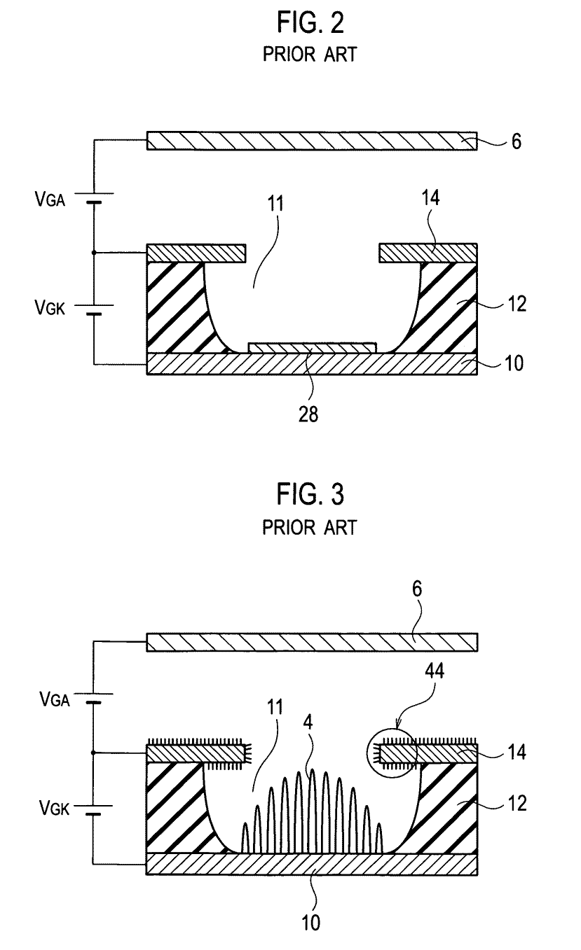

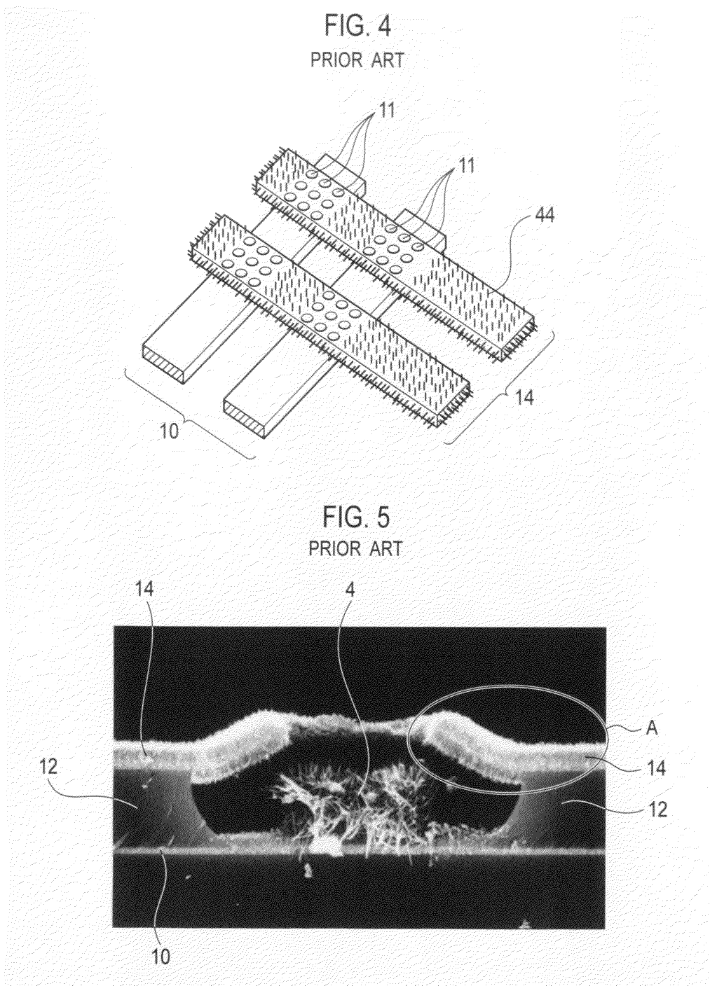

### DETAILED DESCRIPTION OF THE EMBODIMENTS

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified. Generally, and as is conventional in the representation of the circuit blocks, it will be appreciated that the various drawings are not drawn to scale from one figure to another nor inside a given figure, and in particular that the circuit diagrams are arbitrarily drawn for facilitating the reading of the drawings. In the following descriptions, numerous specific details are set forth such as specific signal values, etc. to provide a thorough understanding of the present invention. However, it will be obvious to those skilled in the art that the present invention may be practiced without such specific details. In other instances, circuits well-known have been shown in block diagram form in order to not obscure the present invention with unnecessary detail.

The embodiments shown below exemplify an apparatus and a method that are used to implement the technical ideas according to the present invention, and do not limit the technical ideas according to the present invention to those that appear below. These technical ideas, according to the present invention, may receive a variety of modifications that fall within the claims.

In addition, in the following description, CNT (Carbon Nano-Tube) is used noting that it is synonymous with CNF (Carbon Nano-Fiber). Even if a minute structure is CNT (Carbon Nano-Tube), it is because it has a shape of CNF (Carbon Nano-Fiber) macroscopically.

Moreover, in the following description, CNT (Carbon Nano-Tube) may be replaced by GNT (Graphite Nano-Tube). That is, shape of a graphite nano-sheet may be provided instead of CNT (Carbon Nano-Tube).

Similarly, in the following description, GNT (Graphite Nano-Tube) is used noting that it is synonymous with GNF (Graphite Nano-Fiber). Even if a minute structure is GNT (Graphite Nano-Tube), it is because it has a shape of GNF (Graphite Nano-Fiber) macroscopically.

### First Embodiment

### (Fabrication Method for Carbon Fiber)

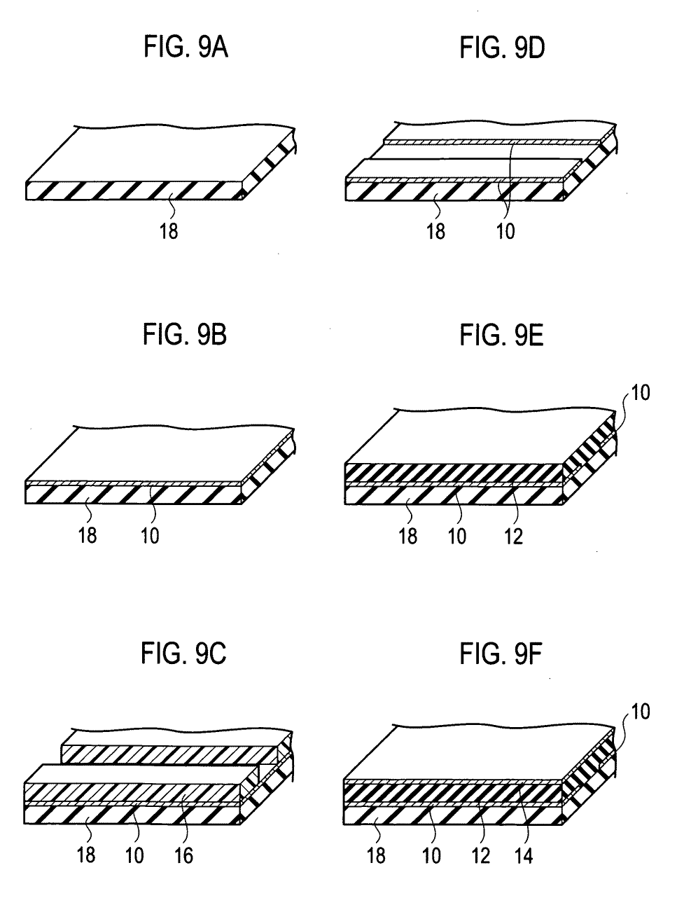

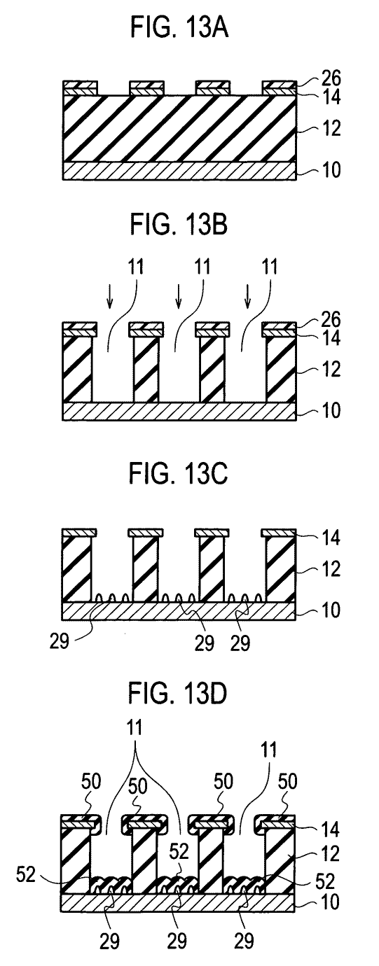

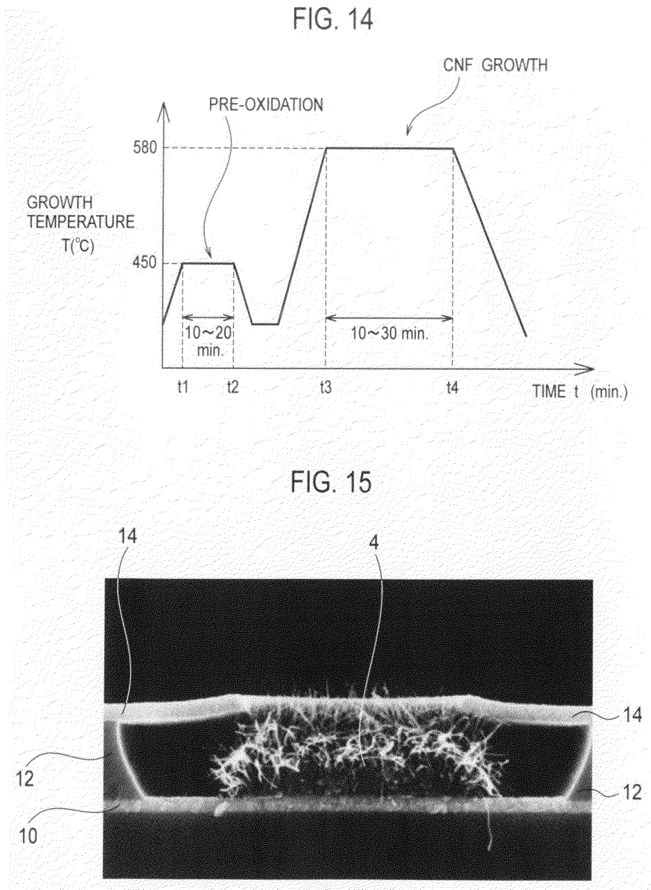

A fabrication method for carbon fiber according to a first embodiment of the present invention includes a formation process of minute holes by dry etching, an ultrasonic catalyst plating process, a previous oxidation process and a growing process of a carbon nano-tube. The formation process of minute holes by dry etching is shown in FIG. 9 to FIG. 11 and FIG. 13A to FIG. 13B. The ultrasonic catalyst plating process is shown in FIG. 12 and FIG. 13C. The previous oxidation process and the growing process of the carbon nano-tube are shown in FIG. 13D and FIG. 14.

An experimental result by the fabrication method for carbon fiber according to the first embodiment of the present invention is as being shown in FIG. 15 to FIG. 22.

The fabrication method for carbon fiber according to the first embodiment of the present invention has the characteristic at a point of performing the previous oxidation process, at the time of growth of carbon fibers, such as CNT and GNF.

Accordingly, abnormal growth of the surface of the gate electrode 14 can be prevented, and abnormal electron emission from a gate electrode line can be prevented. Moreover, since growth of the carbon fiber is achieved from an oxidized catalyst, it is possible of growth of the carbon fiber selectively from an oxidized catalytic metal.

Furthermore, abnormal growth on the surface of the cathode electrode 10 can also be prevented through the previous oxidation process.

That is, abnormal growth is performed also from a wiring metal (Cr, Mo) of the gate electrodes 14 and the cathode electrode 10 of low catalytic ability except a catalytic metal (Fe, Ni, Co), at the time of growth of the carbon fiber. Abnormal electron emission from the whole wiring occurs because of the abnormal growth being performed from wiring metals (Cr, Mo).

According to the fabrication method for carbon fiber according to the first embodiment of the present invention, it became possible to prevent abnormal growth from a wiring metal by oxidizing a substrate in advance before a carbon fiber growing process.

Moreover, it is also included in the fabrication method for carbon fiber according to the first embodiment of the present invention an effect using selectivity of growing up from the oxidized catalytic metal (Fe, Ni, Co). For example, even if Fe₂O₃, FeO, NiO, Co₂O₃, and CoO are chemically reduced, and as a result, the catalytic metal had oxidized, the carbon nano-tube 4 grows from an oxidized catalytic metal because Fe, Co, and Ni occur.

Since an insulating film is formed on the surface of the gate electrode 14, the carbon nano-tube 4 grows up more than length with the arbitrary, and it is effective at a point which cannot become electrically short easily when the gate electrode 14 is contacted. At the time of reducing abnormal growth, it does not need to cover an electrode with an insulating film of SiO₂ etc., but a process becomes simple. Moreover, it becomes possible to shorten or to control thickness for the carbon nano-tube 4 grown-up too much for long, by oxidizing again.

The fabrication method for carbon fiber according to the first embodiment of the present invention, as shown in FIG. 9 to FIG. 14, includes: a process of forming a cathode electrode 10 on a substrate 18; a process of forming a first insulating film 12 on the cathode electrode 10; a process of forming a gate electrode 14 on the first insulating film 12; a process of forming a hole 11 for reaching up to the surface of the cathode electrode 10 into the first insulating film 12; a process of forming a catalyst crystallite nucleus 29 on the bottom of the hole 11; a process of previous oxidation for forming a second insulating film 50 on the surface of the gate electrode 14; and a process of forming a carbon nano-tube 4 on the catalyst crystallite nucleus 29.

Moreover, when forming the catalyst crystallite nucleus 29, it further includes a process for making the cathode electrode 10 electrodepositing as the negative cathode within a plating bath 34, and a process of applying an ultrasonic wave to the plating bath 34.

Moreover, in the previous oxidation process, it may include a process of also oxidizing the surface of the cathode electrode 10 simultaneously and forming a third insulating film 52.

Moreover, in the previous oxidation process, it may include a process of also oxidizing the surface of the cathode electrode 10 and the surface of the catalyst crystallite nucleus 29 simultaneously, and forming the third insulating film 52 on the surface of the cathode electrode 10 and the surface of the catalyst crystallite nucleus 29.

Moreover, the previous oxidation process is performed before the process of forming the carbon nano-tube 4.

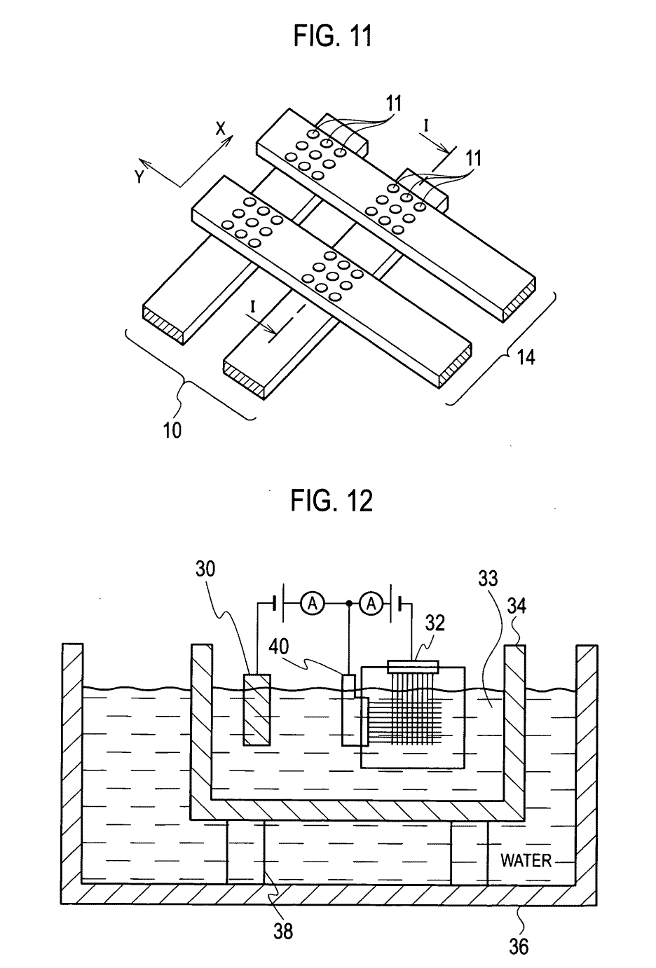

As shown in FIG. 9 to FIG. 14, the fabrication method for carbon fiber according to the first embodiment of the present invention includes: a process of placing field emission matrix electrode structure (FIG. 11) into the plating bath 34, and the field emission matrix electrode structure being composed of the cathode electrode 10 placed on the substrate 18, the first insulating film 12 placed on the cathode electrode 10, the gate electrode 14 placed on the first insulating film 12 and intersecting perpendicularly with the cathode electrode 10, and the hole 11 formed up to the surface of the cathode electrode 10 into the first insulating film 12; a process of electrodepositing catalyst into the hole 11 using the cathode electrode 10 of the bottom of the hole 11 as the negative cathode, and the gate electrode 14 as the positive anode, and adhering the catalyst crystallite nucleus 29 of nano order on the cathode electrode 10 of the bottom of the hole 11, when the catalyst becomes a nucleus of carbon fiber growth; a process of oxidizing the surface of the gate electrode 14 and forming the second insulating film 50 according to the previous oxidation process; and a process of growing up the carbon nano-tube 4 to the catalyst crystallite nucleus 29.

Moreover, in a process to which the catalyst crystallite nucleus 29 is made to adhere, it includes a process of applying an ultrasonic wave to the plating bath 34.

Moreover, the gate electrode 14 is composed of a substance which cannot dissolve easily, for example, metal in which an ionization tendency is higher than catalyst ion or carbon, Pt, Au, Si, etc. An extraction electrode (gate electrode 14) act as the positive anode is etched and ionized. Therefore, it is because it is effective to select a substance which cannot dissolve easily, metal in which an ionization tendency is higher than catalyst ion or carbon, Pt, Au, Si, etc., as the gate electrode (positive anode) 14 in order to prevent a re-deposit to the cathode electrode (negative cathode) 10.

Moreover, as shown in FIG. 9 to FIG. 14, the fabrication method for carbon fiber according to the first embodiment of the present invention includes: a process of placing field emission matrix electrode structure (FIG. 11) into the plating bath 34, and the field emission matrix electrode structure being composed of the cathode electrode 10 placed on the substrate 18, the first insulating film 12 placed on the cathode electrode 10, the gate electrode 14 placed on the first insulating film 12 and intersecting perpendicularly with the cathode electrode 10, and the hole 11 formed up to the surface of the cathode electrode 10 into the first insulating film 12; a process of making the cathode electrode 10 opposing centering on the gate electrode 14, and placing the opposite negative cathode 30 in the plating bath 34, and making potential of the opposite negative cathode 30 into lower voltage than the gate electrode 14; a process of electrodepositing catalyst into the hole 11 using the cathode electrode 10 of the bottom of the hole 11 as the negative cathode, and the gate electrode 14 as the positive anode, and adhering the catalyst crystallite nucleus 29 of nano order on the cathode electrode 10 of the bottom of the hole 11, when the catalyst becomes a nucleus of carbon fiber growth; a process of oxidizing the surface of the gate electrode 14 and forming the second insulating film 50 according to the previous oxidation process; and a process of growing up the carbon nano-tube 4 to the catalyst crystallite nucleus 29.

Moreover, in a process to which the catalyst crystallite nucleus 29 is made to adhere, it includes a process of applying an ultrasonic wave to the plating bath 34.

The fabrication method for carbon fiber according to the first embodiment of the present invention is cheaper than a catalyst sputtering method in respect of an apparatus, and the complicated catalyst lift-off process is unnecessary. Moreover, since distance and potential between the anode electrode and the cathode electrode are fixed with catalyst plating method, the uniform catalyst crystallite nucleus 29 into the hole 11 can be formed, by increase of an aspect ratio by enlargement of the emission matrix, and a miniaturization of the hole. On the other hand, the uniform catalyst fabrication is impossible in the catalyst sputtering method because of sputtering angle of skew entering for the hole 11 by enlargement of the emission matrix, and a miniaturization of the hole.

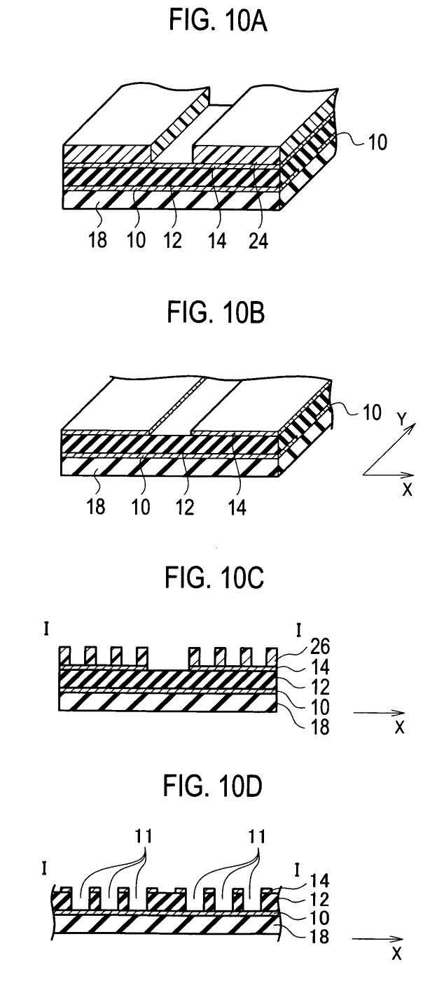

In the fabrication method for carbon fiber according to the first embodiment of the present invention, after forming minute holes by dry etching, the gate electrode 14 of a substrate which removed the resist 26 (FIG. 10C) by oxygen-ashing is used as the positive anode and the cathode electrode 10 is used as the negative cathode, and the bottom of the hole 11 is made to electrodepositing the catalyst in the plating bath 34. In order to prevent abnormal catalyst nucleus growth at the time of plating and to make the electrolytic solution 33 for plating introducing into the minute holes, electrodepositing plating is performed through applying an ultrasonic wave. This can prevent a cavitation bubbling of the electrolytic solution 33 in the minute holes.

At the time of plating, when a voltage clamp of the gate electrode 14 and the cathode electrode 10 is imperfect, the catalyst may perform abnormal electro-deposition at the gate electrode 14, which is a positive anode. In this case, catalyst electro-deposition to the positive anode can be prevented by introducing a triode structure, provided with one more opposite negative cathode 30, in order to etch the positive anode more.

At the time of plating, even if an anode electrode is dissolved into the electrolytic solution 33, re-deposition of the metal to the cathode electrode can be controlled, by using metal with a larger ionization tendency than catalyst ion as an electrode material of the gate electrode (anode plate) 14. Or, a conductor, which is not dissolved into the electrolytic solution 33, can also be used as the gate electrode (anode plate) 14.

In the fabrication method for carbon fiber according to the first embodiment of the present invention, even if the lift-off process is a difficult process as for dry etching holes 11, the catalyst crystallite nucleus 29 can be easily formed on the bottom of the holes 11. In particular, also when an aspect ratio of the hole is high, the catalyst crystallite nucleus 29 can be easily formed on the bottom of the hole.

In the fabrication method for carbon fiber according to the first embodiment of the present invention, as shown in FIG. 11, a plurality of holes 11 in one dot formed in an intersection of the gate electrode 14 and the cathode electrode 10 is made with high density, and the amount of emission current per dot increases in the field emission matrix electrode structure. In order to increase the amount of emission current per dot, it is advantageous since the case of forming the hole 11 by dry etching rather than the case of forming the hole by wet etching can make high formation density of the catalyst crystallite nucleus 29 to the bottom of the hole 11.

Such as the fabrication method for carbon fiber according to the first embodiment of the present invention, for example, only the thin carbon nano-tube 4 about 10 nm phi grows, a deposit of amorphous carbon which is by-product material is no longer seen, and its quality (purity) of the fiber improves, by adding ultrasonic technique to catalyst plating technology. The catalyst is electro-deposited by only the cathode electrode (negative cathode electrode) 10 by placing the opposite cathode 30 for etching positively the gate electrode (positive anode plate) 14 other than the cathode electrode (negative cathode electrode) 10 in which a deposit of the catalyst crystallite nucleus 29 is achieved.

In the fabrication method for carbon fiber according to the first embodiment of the present invention, cheap and equalized and minute CNF can be formed using ultrasonic catalyst plating method with a simple apparatus configuration, without using an expensive catalyst sputtering apparatus.

According to the fabrication method for carbon fiber according to the first embodiment of the present invention, by performing ultrasonic catalyst plating so that current may flow only into an aimed part on a conductor substrate which wishes to grow, the whole of the aimed part is electro-deposited and a carbon fiber can be grown up to be only the aimed part.

Moreover, in the fabrication method for carbon fiber according to the first embodiment of the present invention, a mass production method of a carbon fiber of high purity of uniform thickness and length can be provided.

According to the fabrication method for carbon fiber according to the first embodiment of the present invention, abnormal growth from a wiring metal can be prevented oxidizing a substrate in advance before the growing process of the carbon nano-tube.

Moreover, according to the fabrication method for carbon fiber according to the first embodiment of the present invention, selectivity of which the carbon nano-tube grows from the oxidized catalytic metal can be used.

Moreover, according to the fabrication method for carbon fiber according to the first embodiment of the present invention, since an insulating film is formed on the surface of the gate electrode, when the carbon fiber grows up more than arbitrary length and contacts the gate electrode, it is hard to become electrically short.

Moreover, according to the fabrication method for carbon fiber according to the first embodiment of the present invention, when reducing abnormal growth, it does not need to cover the electrode with the insulating film of SiO2 etc., but a process becomes simple.

Moreover, according to the fabrication method for carbon fiber according to the first embodiment of the present invention, it becomes possible to shorten or to control thickness for the carbon fiber grown-up too much for long, by oxidizing again.

According to the fabrication method for carbon fiber according to the first embodiment of the present invention, the abnormal growth from electrode wiring metal can be prevented by a simple and cheap method using ultrasonic selectively catalyst plating method by using a field emission matrix electrode, and the carbon nano-tube of nano order based on a catalyst crystallite nucleus of nano order can be formed with high density and uniform.

### (Carbon Fiber Electron Source and FED Device)

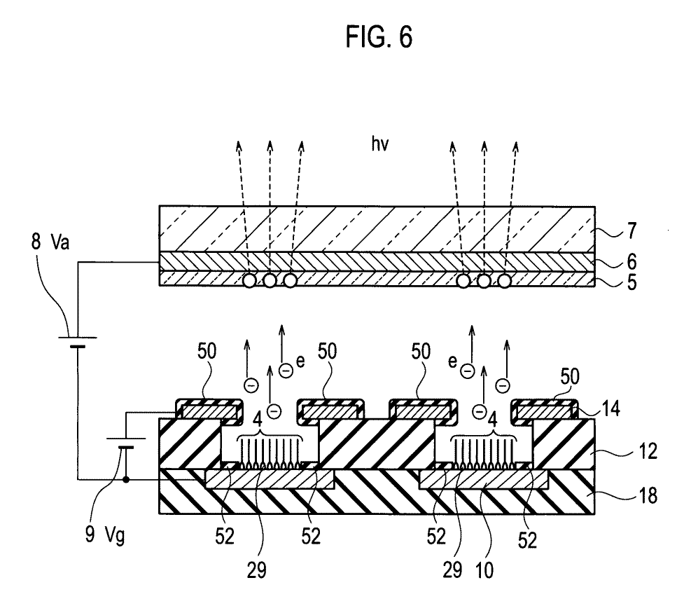

A schematic section structure chart of a CNT-FED device formed by using the fabrication method for carbon fiber according to the first embodiment of the present invention is shown in FIG. 6.

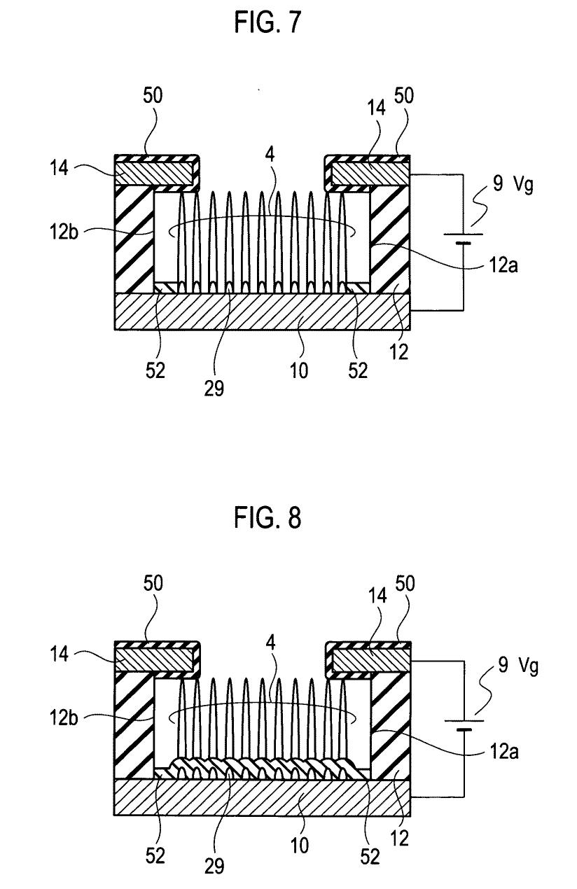

Moreover, an expanded schematic section structure chart of a carbon fiber electron source formed by using the fabrication method for carbon fiber according to the first embodiment of the present invention is shown in FIG. 7.

Moreover, an expanded schematic section structure chart of another carbon fiber electron source formed by using the fabrication method for carbon fiber according to the first embodiment of the present invention is shown in FIG. 8.

As shown in FIG. 7 or FIG. 8, a carbon fiber electron source applying the carbon fiber fabricated by using the fabrication method for carbon fiber according to the first embodiment of the present invention includes: a cathode electrode 10 placed on a substrate 18; a first insulating film 12 placed on the cathode electrode 10; a gate electrode 14 placed on the first insulating film 12; a catalyst crystallite nucleus 29 formed on the bottom of a hole 11 formed up to the surface of the cathode electrode 10 into the first insulating film 12; a second insulating film 50 formed on the surface of the gate electrode 14; and a carbon nano-tube 4 formed on the catalyst crystallite nucleus 29.

As shown in FIG. 6, a CNT-FED device applying the carbon fiber fabricated by using the fabrication method for carbon fiber according to the first embodiment of the present invention includes: the cathode electrode 10 placed on the substrate 18; the first insulating film 12 placed on the cathode electrode 10; the gate electrode 14 placed on the first insulating film 12; an anode electrode 6 placed on the upper part of the gate electrode 14 of the opposite side of the cathode electrode 10, the gate electrode 14 being placed in the middle; the catalyst crystallite nucleus 29 formed on the bottom of the hole 11 formed up to the surface of the cathode electrode 10 into the first insulating film 12; the second insulating film 50 formed on the surface of the gate electrode 14; the carbon nano-tube 4 formed on the catalyst crystallite nucleus 29; and a fluorescent material 5 placed on the back side which opposes the cathode electrode 10 of the anode electrode 6.

Anode power supply Vₐ which makes the anode electrode 6 positive electric potential and makes the cathode electrode 10 negative electric potential is applied between the anode electrode 6 and the cathode electrode 10, and acceleration voltage of an electron is given between the anode electrode 6 and the cathode electrode 10. Moreover, gate power supply V_{g} which makes the gate electrode 14 positive electric potential and makes the cathode electrode 10 negative electric potential is applied between the gate electrode 14 and the cathode electrode 10, and extractor voltage of an electron from the carbon nano-tube 4 is given between the gate electrode 14 and the cathode electrode 10. An amount of electrons extracted (emitted) from the carbon nano-tube 4 by the gate power supply V_{g} applied between the gate electrode 14 and the cathode electrode 10 reaches the anode electrode 6 by acceleration voltage between the anode electrode 6 and the cathode electrode 10. An amount of electrons enters into the fluorescent material 5 on the back-side surface of the anode electrode 6, and emits desired fluorescent emission. It is about several micrometers or less, for example, between the anode electrode 6 and the cathode electrode 10 and, also it is maintained at a vacuum.

According to the carbon fiber electron source applying the carbon fiber fabricated by using the fabrication method for carbon fiber according to the first embodiment of the present invention, high-output current density is realizable.

According to the CNT-FED device which applying the carbon fiber fabricated by using the fabrication method for carbon fiber according to the first embodiment of the present invention, high-intensity with high current density, large capacity, and a big screen are realizable.

### (Formation Process of Minute Holes by Dry Etching)

A schematic section structure chart, showing one process of the fabrication method for carbon fiber by minute holes formation by dry etching as the first embodiment of the present invention, is shown in FIG. 9. FIG. 9A shows a process chart which prepares a substrate, FIG. 9B shows a cathode electrode formation process chart by sputtering, FIG. 9C shows a cathode line photo lithography process chart after a resist application, FIG. 9D shows a lift off process chart after cathode electrode formation, FIG. 9E shows an insulating film depositing process chart, and FIG. 9F shows a gate electrode formation process chart by sputtering, respectively.

Furthermore, a schematic section structure chart showing one process of the fabrication method for carbon fiber, following to FIG. 9F is shown in FIG. 10. FIG. 10A shows a gate line photo lithography process chart after a resist application, FIG. 10B shows a lift off process chart after gate electrode line etching, FIG. 10C shows a minute holes pattern formation process chart after a resist application, and FIG. 10D shows a resist-ashing process chart after hole dry etching, respectively.

FIG. 13 is a schematic section structure chart showing one process of a fabrication method for carbon fiber by dry hole formation as the first embodiment of the present invention, and shows a process chart after a process of FIG. 10 (a part overlaps with FIG. 10C and FIG. 10D). FIG. 13A shows a resist patterning process chart, FIG. 13B shows a hole formation process chart by dry etching, FIG. 13C shows a formation process chart of a catalyst crystallite nucleus by ultrasonic selectively catalyst plating method, and FIG. 13D shows a previous oxidation process chart.

The fabrication method will be explained in the following.
(a) First of all, as shown in FIG. 9A, prepare a substrate 18 composed of a glass substrate, SiO₂ substrate, a silicon substrate, etc.
(b) Next, as shown in FIG. 9B, form a cathode electrode 10 by using sputtering technology etc. As a material of the cathode electrode 10, Cr, Mo, etc. can be used, for example.
(c) Next, as shown in FIG. 9C, after forming a resist 16, pattern the resist 16 according to a photo lithography process in order to form stripe shape of the cathode electrode 10.
(d) Next, as shown in FIG. 9D, form stripe shape of the cathode electrode 10 by etching according to a lift-off process.
(e) Next, as shown in FIG. 9E, deposit a first insulating film 12 on the stripe pattern of the cathode electrode 10, and the exposed substrate 18. As a material of the first insulating film 12, SiO₂ film etc. which were formed by the CVD (Chemical Vapor Deposition) method can be used, for example.
(f) Next, as shown in FIG. 9F, form a gate electrode 14 by using sputtering technology, vacuum evaporation technology, or the like. As a material of the gate electrode 14, Cr, Mo, etc. can be used, for example.
(g) Next, as shown in FIG. 10A, after forming a resist 24, pattern the resist 24 according to a photo lithography process, in order to form stripe shape of the gate electrode 14.
(h) Next, as shown in FIG. 10B, form stripe shape of the gate electrode 14 by etching according to a lift-off process. An XY direction which intersects perpendicularly mutually in FIG. 10B corresponds to an XY direction of FIG. 11 mentioned later. The direction of X is the elongating direction of the cathode electrode 10, and the direction of Y is the elongating direction of the gate electrode 14.
(i) Next, as shown in FIG. 10C and FIG. 13A, after forming a resist 26, pattern the resist 26 according to a photo lithography process, and form a dry etching pattern for forming the hole 11.
(j) Next, as shown in FIG. 10D and FIG. 13B, remove the resist 26 by ashing process, after removing the first insulating film 12 composed of SiO₂ film and the gate electrode 14 composed of Cr, by dry etching for forming the hole 11. FIG. 10C and FIG. 10D are corresponding to section structure taken in the line I-I of FIG. 11 mentioned later, schematically. RIE (Reactive Ion Etching) technology etc. can be used for the above-mentioned dry etching technology, for example.
(k) Next, as shown in FIG. 13C, form a catalyst crystallite nucleus 29 on the surface of the cathode electrode 10 in the hole by using ultrasonic catalyst plating method mentioned later.
(l) Next, as shown in FIG. 13D, form a second insulating film 50 on the surface of the gate electrode 14 by a previous oxidation process mentioned later, and then form a third insulating film 52 on the surface of the cathode electrode 10 and the surface of the catalyst crystallite nucleus 29.

FIG. 11 shows a field emission matrix electrode of CNT-FED formed by using the fabrication method for carbon fiber according to the first embodiment of the present invention, and shows a schematic perspective diagram of 2×2 matrices which stuffed a plurality of holes 11 into one dot. In addition, in FIG. 11, the first insulating film 12 is omitting illustration.

In the case of the fabrication method for carbon fiber by a minute holes formation process by dry etching, since the hole 11 is perpendicularly formed by a high aspect ratio by dry etching as shown in FIG. 10D, density growth of the arrangement density of the hole 11 can be performed in high-density levels at an intersection (one dot) between the cathode electrode 10 and the gate electrode 14 which compose a field emission matrix electrode.

In field emission matrix electrode structure, a plurality of holes 11 is fabricated with high density in one dot formed in the intersection between the gate electrode 14 and the cathode electrode 10, and the amount of emission current per dot increases.

Since the case where the hole is formed by dry etching rather than the case where the hole is formed by wet etching can make formation density of the catalyst crystallite nucleus high to the bottom of the hole, it is advantageous in order to increase the amount of emission current per dot.

### (Ultrasonic Catalyst Plating Process)

A schematic configuration diagram of an ultrasonic catalyst plating apparatus used for the fabrication method for carbon fiber according to the first embodiment of the present invention is shown in FIG. 12.

As shown in FIG. 12, the ultrasonic catalyst plating apparatus used for the fabrication method for carbon fiber according to the first embodiment of the present invention includes: an ultrasonic bath 36 for storing water; a plating bath 34 housed in the ultrasonic bath 36 and stores an electrolytic solution 33; a holding stand 38 for connecting between an internal wall of the ultrasonic bath 36 and an outer wall of the plating bath 34, and for holding the plating bath 34 in the ultrasonic bath 36; a field emission matrix electrode structure composed of a plurality of gate electrodes 14 and a plurality of cathode electrodes 10 which cross mutually and an opposite cathode 30 and the field emission matrix electrode structure and the opposite cathode 30 are being dipped in the electrolytic solution 33 in the plating bath 34; a clip 40 for gate electrodes for connecting a plurality of gate electrodes 14; and a clip 32 for cathode electrodes for connecting a plurality of cathode electrodes 10.

In the ultrasonic catalyst plating used for the fabrication method for carbon fiber according to the first embodiment of the present invention, the opposite cathode 30 is provided in order to reduce the dissolution of the gate electrode (anode plate) 14, and voltage which makes the gate electrode 14 positive potential and makes the opposite cathode 30 electro-negative potential is applied between the opposite cathode 30 and the gate electrode 14. Moreover, voltage, which makes the gate electrode 14 positive potential and makes the cathode electrode (cathode) 10 electro-negative potential, is applied between the cathode electrode (cathode) 10 and the gate electrode 14.

In the ultrasonic catalyst plating method used for the fabrication method for carbon fiber according to the first embodiment of the present invention, the clip 40 is preferable to use the same metal as a catalytic metal, since the gate electrode (anode plate) 14 has a possibility of dissolving into the electrolytic solution 33 in the plating bath 34. Or it is preferable to take conduction of a plurality of gate electrodes (anode plate) 14 by using the clip 40 etc. which are composed of a conductor not dissolving. A part of the cathode electrodes 10 except the hole 11 is not plated since it is covered with the first insulating film 12. Only the cathode electrode 10 in the hole 11 is plated.

### —Ionization Tendency—

At this point, as an electrode material used for the gate electrode (positive anode) 14, if Fe is used as the catalytic metal, metal, such as Cr with a larger ionization tendency rather than Fe, is used. It is the purpose to make a metal ion dissolved into the electrolytic solution 33 not deposit with the priority to the cathode electrode (negative cathode) 10.

The ionization tendency is expressed with: K>Na>Sr>Ca>Mg>Al>Ce>Cr>Mn>Zn>Cd>Fe>Co>Ni>Sn>Pb>(H)>Ge>In>Sb>Bi>Cu>Hg>Ag>Pt>Au>Si>Ti>C>W>Mo>Se.

Therefore, as the electrode material used for the gate electrode (positive anode) 14, if Fe is used as a catalytic metal, the ionization tendency is larger than Fe, for example, metallic materials, such as Mg, Al, Ce, Cr, Mn, Zn, and Cd, is applied.

As catalytic metal salt for dissolving into the electrolytic solution 33, FeCl₂4H₂O, FeCl₃6H₂O, Fe(SO₄)7H₂O, Fe(NH₄)₂(SO₄)6H₂O, etc. can be used, for example, if it is Fe ion.

As catalytic metal salt for dissolving into the electrolytic solution 33, CoSO₄7H₂O, CuSO₄(NH)₂6H₂O, CoCl₂6H₂O, etc. can be used, for example, if it is Co ion.

As catalytic metal salt for dissolving into the electrolytic solution 33, NiO, NiSO₄7H₂O, NiCl₂6H₂O, NiSO₄(NH₄)SO₄6H₂O, etc. can be used, for example, if it is Ni ion.

In addition, the material including a chloride needs to care about a point which emits gaseous chlorine in the gate electrode (positive anode) 14.

### (Previous Oxidation Process and Growing Process of Carbon Nano-Tube)

Acetone and alcoholic cleaning are performed for the substrate 18 after plating, and residual plating ion components are removed. As a growth apparatus of the carbon fiber, a thermal CVD apparatus and a plasma CVD apparatus can be used, for example. As growing gas, CH₄, C₂H₂, CO, methanol, ethanol, etc. are applicable, for example. As carrier gas, Ar, H₂, He, etc. are applicable, for example. The wide range of about 450 degrees C. to about 800 degrees C. can be used for growth temperature, for example. In using a glass substrate as the substrate 18, growth temperature shall be about 650 degrees C. or less, for example. Growth time is about 5 minutes to about 120 minutes, for example. The growth time is various by growth temperature, a type of gas, and a catalyst.

In the fabrication method for carbon fiber according to the first embodiment of the present invention, FIG. 14 shows a growing process of the carbon nano-tube which performs previous oxidation, and shows a schematic diagram explaining relation between growth temperature and growth time.

As shown in FIG. 14, the previous oxidation process is about 450 degrees C., and is performed about 10 minutes to about 20 minutes in the time t1 to t2. In a previous oxidation process, it oxidizes by introducing air. Accordingly, a surface portion of the catalyst crystallite nucleus 29 formed on a surface portion of the gate electrode 14, a surface portion of the cathode electrode 10, and a surface of the cathode electrode 10 can be oxidized. It pulls a vacuum once afterward, and according to the growing process of the carbon nano-tube afterward, in the time t3 to t4, at about 580 degrees C., about 10 minutes to about 30 minutes, CO/H2 gas is introduced, for example and the carbon nano-tube 4 is grown up. The temperature conditions of the above-mentioned previous oxidation process and growing process of the carbon nano-tube 4 are one example. Experimentally, previous oxidation can be verified, for example from about 350 degrees C. Moreover, the growth temperature of the carbon nano-tube 4 is arbitrary, for example, the growth of the carbon nano-tube 4 from equal to or more than 500 degrees C. is verified.

In a constructional example of a carbon fiber electron source shown in FIG. 7, the catalyst crystallite nucleus 29 is coated by plating grows on the cathode electrode 10 in the hole 11 surrounded with the hole inner side walls 12a and 12b, and the carbon nano-tube 4 is growing directly on the catalyst crystallite nucleus 29. The surface of the gate electrode 14 and the surface of the cathode electrode 10 oxidize beforehand by the previous oxidation process, the second insulating film 50 and the third insulating film 52 are formed, respectively, and abnormal growth from the gate electrode 14 and the cathode electrode 10 is prevented. Moreover, a short circuit is prevented by the second insulating film 50 even if a part of the carbon nano-tube 4 contacts near the gate electrode 14. That is, in the structure shown in FIG. 7, since the second insulating film 50 is formed on the surface of the gate electrode 14, when the carbon nano-tube 4 grows up equal to or more than arbitrary length and contacts the gate electrode 14, it is effective at a point which cannot become electrically short easily.

Or moreover, in the constructional example of the carbon fiber electron source shown in FIG. 8, the catalyst crystallite nucleus 29 coated by plating grows on the cathode electrode 10 in the hole 11 surrounded with the hole inner side walls 12a and 12b, and the surface of the gate electrode 14, the surface of the cathode electrode 10, and the catalyst crystallite nucleus 29 oxidize beforehand according to the subsequent previous oxidation process. And then, since the second insulating film 50 is formed on the surface of the gate electrode 14 and the third insulating film 52 is formed on the surface of the cathode electrode 10 and the catalyst crystallite nucleus 29, respectively, abnormal growth from the gate electrode 14 and the cathode electrode 10 is prevented. At this point, selectivity that the carbon nano-tube 4 grows from the oxidized catalytic metal (Fe, Ni, Co) is used. For example, Fe₂O₃, FeO, NiO, Co₂O₃, and CoO are chemically reduced, and as a result, even if the catalytic metal is oxidized, the carbon nano-tube 4 grows from the oxidized catalytic metal since Fe, Co, and Ni occur.

Moreover, since the second insulating film 50 is formed on the surface of the gate electrode 14, when the carbon nano-tube 4 grows up equal to or more than the arbitrary length and contacts the gate electrode 14, a point which cannot become electrically short easily is the same as that of FIG. 7. When reducing the abnormal growth, it does not need to cover the electrode with the insulating film of SiO₂ etc., but a process becomes simple.

Moreover, it becomes possible to shorten or to control thickness for the carbon nano-tube 4 grown-up too much for long, by oxidizing again.

In the structure shown in FIG. 7 and FIG. 8, electron emission is achieved from a point edge of the carbon nano-tube 4 by applying voltage between the gate electrode and the cathode electrode through the gate power supply V_{g} after the growth of the carbon nano-tube 4, in the fabrication method for carbon fiber according to the first embodiment of the present invention. The electron emission is achieved by applying voltage between the gate electrode and the cathode electrode and between the anode electrode and the cathode electrode, after the growth of the carbon nano-tube 4.

### (Result of Experiment)

An expanded cross section SEM photograph of a carbon fiber obtained as a result of growing up a carbon nano-tube after a previous oxidation process, in the fabrication method for carbon fiber according to the first embodiment of the present invention, is shown in FIG. 15. Although when a carbon nano-tube is grown up without the previous oxidation, as shown in FIG. 5, the abnormal growth from the gate electrode (Cr) 14 is seen, when the carbon nano-tube 4 is grown up after the previous oxidation process, the abnormal growth is not seen as shown in FIG. 15.

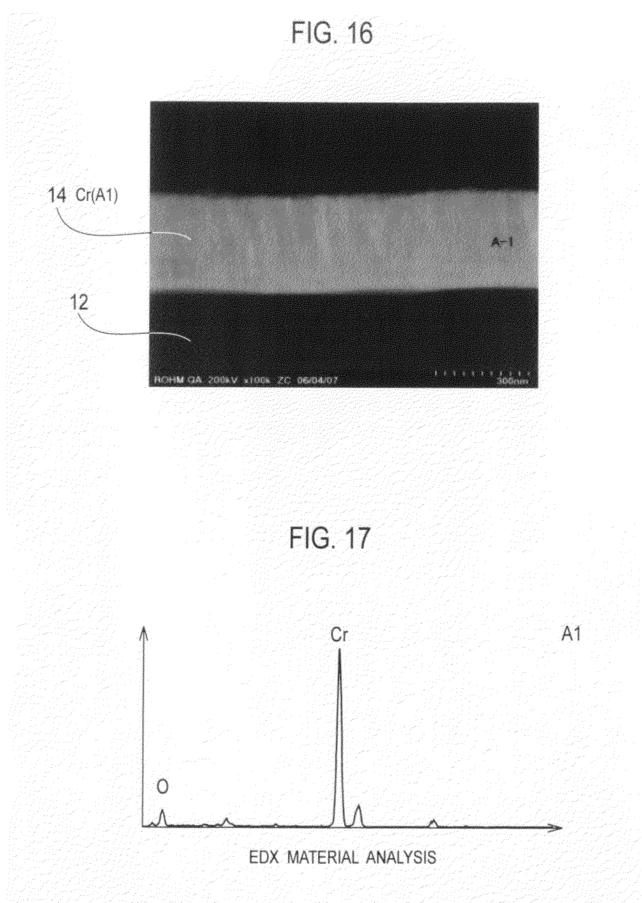

An expanded cross section SEM photograph near the gate electrode before a previous oxidation process, in the fabrication method for carbon fiber according to the first embodiment of the present invention, is shown in FIG. 16. The gate electrode (Cr) 14 on the first insulating film 12 before the previous oxidation process is shown in FIG. 16.

A material analysis result by EDX (Energy Dispersive X-ray Fluorescence Spectrometer) of the reference numeral A1 part of the gate electrode (Cr) 14 of FIG. 16 is shown in FIG. 17. Although a peak of oxygen (O) by natural oxidation is observed, a peak of chromium (Cr) element, which is mainly a chief material of the gate electrode 14 is observed.

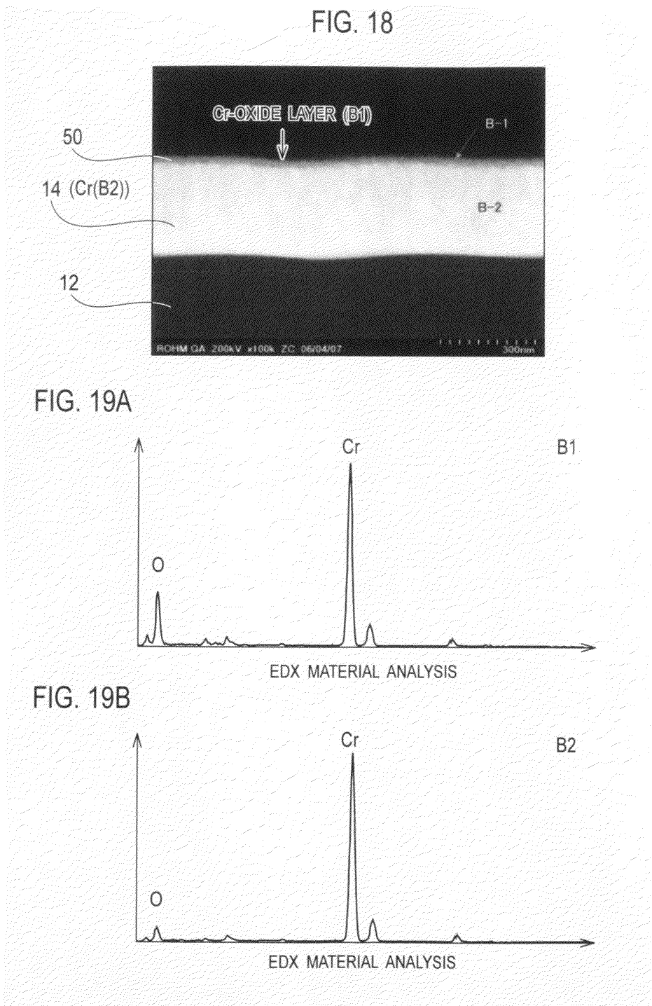

An expanded cross section SEM photograph near the gate electrode after the previous oxidation process, in the fabrication method for carbon fiber according to the first embodiment of the present invention is shown in FIG. 18. The gate electrode (Cr) 14 on the first insulating film 12 and the second insulating film 50 after the previous oxidation process are shown in FIG. 18.

Cr metal of the gate electrode 14 oxidizes and chromium oxidation films, such as Cr₂O₃ and CrO₃, are formed. A rate of the previous oxidation of Cr metal of the gate electrode 14 is about 30 nm in a growing atmosphere for about 10 minutes to 30 minutes, for example. That is, as thickness of the second insulating film 50, oxide film thicknesses of about 30 nm are required. It is because the gate electrode 14 is chemically reduced by reducing gas (Cr₂O₃→Cr), catalytic ability recovers and abnormal growth occurs, in the above-mentioned processing time at natural oxidation film thickness (for example, about 10 nm or less).

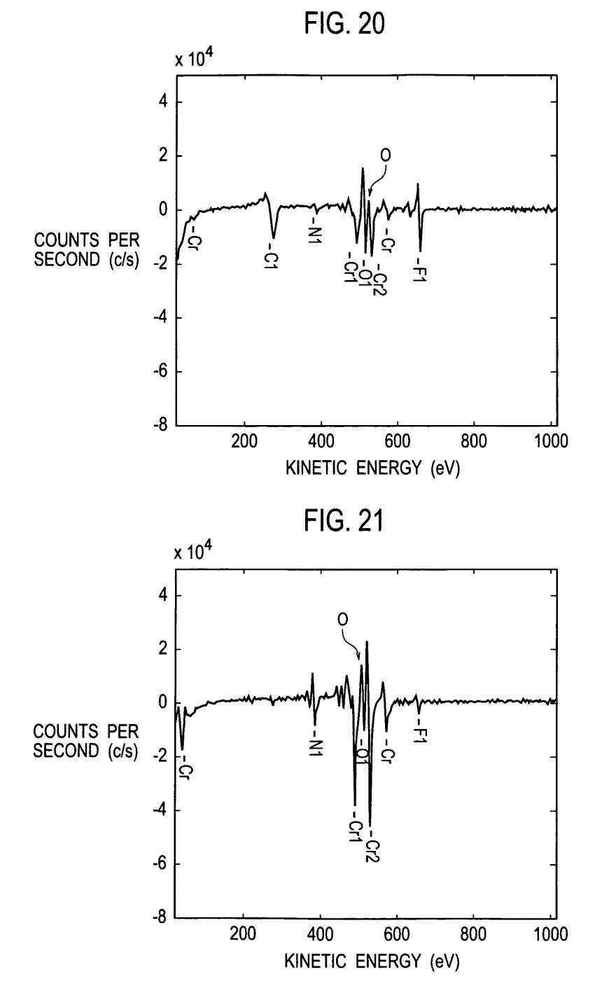

As shown in FIG. 20 to FIG. 22 mentioned later, in order to prevent the abnormal growth securely, there should just be equal to or more than 30 nm in the above-mentioned process. If the oxide film thicknesses become thick for the electrode layers thickness, since wiring resistance increases, it is preferable to form the oxide film by about 10% of the electrode layers thickness.

FIG. 19A shows an EDX material analysis result of B1 part in which the insulating film (Cr oxide film) 50 of FIG. 18 is formed, and FIG. 19B shows an EDX material analysis result of B2 part of the gate electrode 14 of FIG. 18, respectively. As clearly from FIG. 19A, a condition that a peak of an oxygen (O) element has come out strongly are observed, and it proves that chromium oxidation films, such as Cr₂O₃ and CrO₃, are formed in B1 part in which the insulating film (Cr oxide film) 50 of FIG. 18 is formed. On the other hand, as clearly from FIG. 19B, although a peak of oxygen (O) by natural oxidation is observed from the EDX material analysis result of B2 part of the gate electrode 14 of FIG. 18, a peak of chromium (Cr) element which is mainly a chief material of the gate electrode 14 is observed.

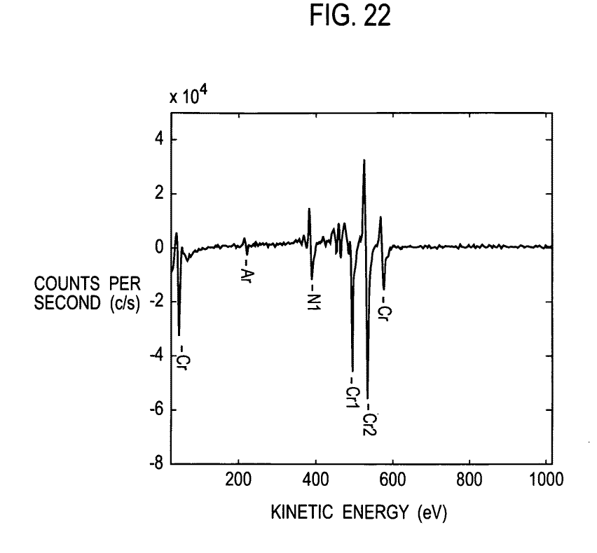

FIG. 20 shows an Auger analysis result of a surface of the natural oxidation Cr of the gate electrode, FIG. 21 shows an Auger analysis result with a depth of 2 nm from a outer layer of the natural oxidation Cr of the gate electrode, and FIG. 22 shows an Auger analysis result with a depth of 10 nm from a outer layer of the natural oxidation Cr of the gate electrode, respectively, in the fabrication method for carbon fiber according to the first embodiment of the present invention.

According to the above-mentioned analysis result, it proves that an oxygen peak exists from the outer layer to a depth of 10 nm, and an oxide film is formed. However, occurring abnormal growth from the gate electrode 14 is observed. This is because it processes by the reducing gas (CO/H₂) etc. at the time of growth of the carbon nano-tube 4, so a thin oxide film is reduced and the catalytic ability recovers. Therefore, in consideration of a reduction treatment time period, it is necessary to determine the oxide film thicknesses. That is, it is necessary to make it film thickness in which the oxide film remains, and a growing atmosphere is about 10 minutes to 30 minutes and the film thickness is about 30 nm, experimentally, as mentioned above. That is, as thickness of the second insulating film 50, the oxide film thicknesses of about 30 nm are required, for example, it is preferable that it is equal to or more than about 30 nm.

According to the fabrication method for carbon fiber according to the first embodiment of the present invention, the abnormal growth from electrode wiring metal can be prevented by a simple and cheap method using ultrasonic selectively catalyst plating using the field emission matrix electrode, and the carbon nano-tube of nano order based on the catalyst crystallite nucleus of nano order can be formed with high density and uniform.

Furthermore, according to the carbon fiber electron source according to the first embodiment of the present invention, the fabricated carbon fiber can be applied with the above-mentioned fabrication method for carbon fiber, and high-output current density can be achieved.

Furthermore, according to the FED device according to the first embodiment of the present invention, the fabricated carbon fiber can be applied with the above-mentioned fabrication method for carbon fiber, and high-intensity with high current density, and large capacity and a big screen can be achieved.

### Other Embodiments

While the present invention is described in accordance with the aforementioned embodiments, it should not be understood that the description and drawings that configure part of this disclosure are to limit the present invention. This disclosure makes clear a variety of alternative embodiments, working examples, and operational techniques for those skilled in the art.

Accordingly, the technical scope of the present invention is defined by the claims that appear appropriate from the above explanation, as well as by the spirit of the invention. Various modifications will become possible for those skilled in the art after receiving the teachings of the present disclosure without departing from the scope thereof.

### INDUSTRIAL APPLICABILITY

According to the fabrication method for carbon fiber of the present invention, it is applicable to an electron source, an electron gun, and a FED devices which apply the fabricated carbon fiber, and is further applicable to wide fields, such as an electron beam lithography system, nano-wiring using a carbon fiber, a carbon electrodes part of an electric double layer capacitor, a carbon electrodes part for fuel cells, and carbon for gas absorption of a gas sensor.

What is claimed is:

1. A fabrication method for carbon fiber comprising:
forming a cathode electrode on a substrate;
forming a first insulating film on the cathode electrode;
forming a gate electrode on the first insulating film;
forming a hole which reaches to a surface of the cathode electrode into the first insulating film;
forming a catalyst crystallite nucleus on a bottom of the hole;
oxidized forming a second insulating film on the gate electrode surface; and
forming a carbon nano-tube on the catalyst crystallite nucleus.

2. The fabrication method for carbon fiber according to claim 1, further comprising:
electrodepositing the cathode electrode as a negative cathode within a plating bath when forming the catalyst crystallite nucleus; and
applying an ultrasonic wave to the plating bath.

3. The fabrication method for carbon fiber according to claim 1, further comprising:
oxidizing also the cathode electrode surface simultaneously and forming a third insulating film, in the oxidized forming the second insulating film.

4. The fabrication method for carbon fiber according to claim 1, further comprising:
oxidizing also the cathode electrode surface and the catalyst crystallite nuclear surface simultaneously, and forming a third insulating film on the cathode electrode surface and the catalyst crystallite nuclear surface, in the oxidized formation.

5. The fabrication method for carbon fiber according to claim 1, wherein
the oxidized forming the second insulating film is performed before the formation of the carbon nano-tube.

6. A fabrication method for carbon fiber comprising:
placing field emission matrix electrode structure into a plating bath, and the field emission matrix electrode structure being composed of a cathode electrode being placed on a substrate, a first insulating film being placed on the cathode electrode, a gate electrode being placed on the first insulating film and intersecting perpendicularly with the cathode electrode, and a hole formed to the cathode electrode surface into the first insulating film;
electrodepositing a catalyst into the hole using the cathode electrode of a bottom of the hole as a negative cathode and the gate electrode as a positive anode, and adhering a catalyst crystallite nucleus of nano order on the cathode electrode of the bottom of the hole, when the catalyst become a nucleus of growth of the carbon fiber is electrodeposited;
oxidizing the gate electrode surface and forming a second insulating film according to a previous oxidation process; and
growing up a carbon nano-tube to the catalyst crystallite nucleus.

7. The fabrication method for carbon fiber according to claim 6, further comprising:
applying an ultrasonic wave to the plating bath, in the adhering the catalyst crystallite.

8. A fabrication method for carbon fiber comprising:
placing field emission matrix electrode structure into a plating bath, and the field emission matrix electrode structure being composed of a cathode electrode being placed on a substrate, a first insulating film being placed on the cathode electrode, a gate electrode being placed on the first insulating film and intersecting perpendicularly with the cathode electrode, and a hole formed to the cathode electrode surface into the first insulating film;
opposing to the cathode electrode centering on the gate electrode, placing an opposite negative cathode into the plating bath, and making potential of the opposite negative cathode into lower voltage than the gate electrode;
electrodepositing a catalyst into the hole using the cathode electrode of a bottom of the hole as a negative cathode and the gate electrode as a positive anode, and adhering a catalyst crystallite nucleus of nano order on the cathode electrode of the bottom of the hole, when the catalyst become a nucleus of growth of the carbon fiber is electrodeposited;
oxidizing the gate electrode surface and forming a second insulating film according to a previous oxidation process; and
growing up a carbon nano-tube to the catalyst crystallite nucleus.

9. The fabrication method for carbon fiber according to claim 8, further comprising:
applying an ultrasonic wave to the plating bath, in the adhering the catalyst crystallite.

10. A carbon fiber electron source comprising:
a cathode electrode placed on a substrate;
a first insulating film placed on the cathode electrode;
a gate electrode placed on the first insulating film;
a catalyst crystallite nucleus formed on a bottom of a hole formed to the cathode electrode surface into the first insulating film;
a second insulating film formed on the gate electrode surface; and
a carbon nano-tube formed on the catalyst crystallite nucleus.

11. A field emission display device comprising:
a cathode electrode placed on a substrate;
a first insulating film placed on the cathode electrode;
a gate electrode placed on the first insulating film;
an anode electrode placing the gate electrode in the middle and placed an upper part of the gate electrode of the opposite side to the cathode electrode;
a catalyst crystallite nucleus formed on a bottom of a hole formed to the cathode electrode surface into the first insulating film;
a second insulating film formed on the gate electrode surface;
a carbon nano-tube formed on said catalyst crystallite nucleus; and
a fluorescent material placed on a back side which opposes the cathode electrode of the anode electrode.
